(19) United States
(12) Patent Application Publication
(10) Pub. No.: US 2007/0135151 A1
(43) Pub. Date: Jun. 14, 2007

(54) Method and apparatus for cooperative diversity reception of wireless communication signals

(76) Inventor: Roger P. Dendy, Phoenix, AZ (US)

Correspondence Address: MOTOROLA, INC., LAW DEPARTMENT, 1303 E. ALGONQUIN ROAD, SCHAUMBURG, IL, 60196, US

(21) Appl. No.: 11/301,133

(22) Filed: Dec. 12, 2005

(51) Int. Cl. H04B 7/15; H04B 7/00

(52) U.S. Cl. 455/517; 455/11.1

(57) ABSTRACT

A device, method, and system for cooperative diversity wireless communication. The method includes detecting at least one relay wireless device (106). A wireless communication link is established with the at least one relay wireless device (106). Forward link address information of a target wireless device (104) is transmitted, via the wireless communication link (118) to the at least one relay wireless device (106) a forward link wireless communication data signal received by the at least one relay wireless device (106). An instruction to transmit to the target wireless device (104) the forward link wireless communication data signal received by the at least one relay wireless device (106) is also transmitted to the at least one relay wireless device (106), via the wireless communication link. The forward link wireless communication data signal being destined for reception by the target wireless device (104).

### FIELD OF THE INVENTION

The present invention generally relates to the field of wireless communications devices, and more particularly relates to improving reception of forward link signals.

### BACKGROUND OF THE INVENTION

The popularity of wireless communication devices has increased drastically in recent times. Wireless communication technology has also improved over the recent years. However, wireless communication signals are sometimes weakened for various reasons such as multi-path fading. When multi-path fading occurs, radio signals are deflected off of obstacles, which cause interference during reception of the signal.

Various prior art systems have tried to overcome the effects of multi-path fading. For example, In CDMA networks, it is common practice for a base station to support more than one receive antenna, which are separated spatially. The signals received at each antenna are combined to combat fading due to multi-path effects on the reverse link. Although improved performance of the signals can be achieved using spatial diversity on the forward link, it is difficult to obtain sufficient spacings between antennas on a mobile wireless device. For example, when two antennas are connected to the same mobile wireless device, these systems face performance limitations due to the close proximity of the antennas necessitated by the small size of the mobile wireless device.

Therefore a need exists to overcome the problems with the prior art as discussed above.

### SUMMARY OF THE INVENTION

Briefly, in accordance with the present invention, disclosed are a method, device, and system for cooperative diversity wireless communication is disclosed. The method includes. The method includes detecting at least one relay wireless device. A wireless communication link is established with the at least one relay wireless device. Forward link address information of a target wireless device is transmitted, via the wireless communication link to the at least one relay wireless device a forward link wireless communication data signal received by the at least one relay wireless device. An instruction to transmit to the target wireless device the forward link wireless communication data signal received by the at least one relay wireless device is also transmitted to the at least one relay wireless device, via the wireless communication link. The forward link wireless communication data signal being destined for reception by the target wireless device.

In yet another embodiment of the present invention, a wireless device for cooperative diversity wireless communication is disclosed. The wireless device comprises a controller for enabling a forward link address information send operation of a target wireless device. The target wireless device also includes a wireless communication link that is communicatively coupled with the controller, for directly communicating with at least one relay wireless communication device. The target wireless device also includes a transmitter that is communicatively coupled with the controller, for transmitting the forward link address information from the target wireless device, via the wireless communication link, to the at least one relay wireless device. The transmitter also transmits and instruction to transmit to the target wireless device, via the wireless communication link, a forward link wireless communication data signal received by the at least one relay wireless device. The forward link wireless communication data signal being destined for reception by the target wireless device.

In yet another embodiment of the present invention, a wireless communication system for cooperative diversity wireless communication is disclosed. The wireless communication system comprises at least one target wireless device. Each such target wireless device comprises a controller for enabling a forward link address information send operation of a target wireless device. The target wireless device also includes a wireless communication link that is communicatively coupled with the controller, for directly communicating with at least one relay wireless communication device. The target wireless device also includes a transmitter that is communicatively coupled with the controller, for transmitting the forward link address information from the target wireless device, via the wireless communication link, to the at least one relay wireless device. The transmitter also transmits and instruction to transmit to the target wireless device, via the wireless communication link, a forward link wireless communication data signal received by the at least one relay wireless device. The forward link wireless communication data signal being destined for reception by the target wireless device.

The at least one relay device comprises a controller and a memory that is communicatively coupled with the controller. The memory stores the forward link address information transmitted from the target wireless device. The relay wireless device also includes a receiver, communicatively coupled with the controller, for receiving at least one forward link wireless communication data signal. The forward link wireless communication data signal is destined for reception by the at least one target wireless device. A wireless communication link, communicatively coupled with the controller is also included in the relay wireless device. The wireless communication link is for at least receiving the forward link address information transmitted by the at least one target wireless device. The wireless communication link is also for at least transmitting a wireless communication data signal corresponding to the at least one forward link wireless communication data signal to the at least one target wireless device.

An advantage of the present invention is that wireless devices receiving a weak forward link signal can have other wireless devices act as a diversity receiver to improve the forward link signal. The wireless devices are then able to combine forward link signals received, for example, from a base station and from the wireless devices acting as diversity receivers in order to obtain a stronger forward link signal. Accordingly, forward link data rates are increased, fewer retransmissions occur, and overall increased throughput per sector is achieved.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a wireless communication system, according to an embodiment of the present invention;

FIG. 2 is a block diagram illustrating a cooperative diversity wireless device for a wireless communication system according to an embodiment of the present invention;

FIG. 3 is a diagram illustrating a cooperative diversity wireless communication group;

FIG. 4 is an operational flow diagram illustrating an exemplary process of establishing a wireless communication link with a cooperative diversity wireless device, according to an embodiment of the present invention;

FIG. 5 is an operational flow diagram illustrating an exemplary process of receiving a wireless communication signal relayed from a cooperative diversity wireless device, according to an embodiment of the present invention; and

FIG. 6 is an operational flow diagram illustrating exemplary process of relaying a wireless communication signal to a cooperative diversity wireless device, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The present invention, according to an embodiment, overcomes problems with the prior art by allowing wireless devices to act as a diversity receiver for one another. Each wireless device is able to receive and relay forward link signals intended for other wireless devices. The relayed signals can be combined with each other and the actual forward link signal received from an originating wireless device to improve the overall strength of the forward link signal. Accordingly, forward link data rates are increased, fewer retransmissions occur, and overall throughout for the sector is increased.

The term wireless device is intended to broadly cover many different types of devices that can wirelessly receive signals, and optionally can wirelessly transmit signals, and may also operate in a wireless communication system. For example, and not for any limitation, a wireless device can include any one or a combination of the following: a cellular telephone, a mobile phone, a smartphone, a two-way radio, a two-way pager, a wireless messaging device, a multi-mode wireless device capable of communicating using more than one voice service such as dispatch (PTT/PoC) and interconnect (cellular), or the like.

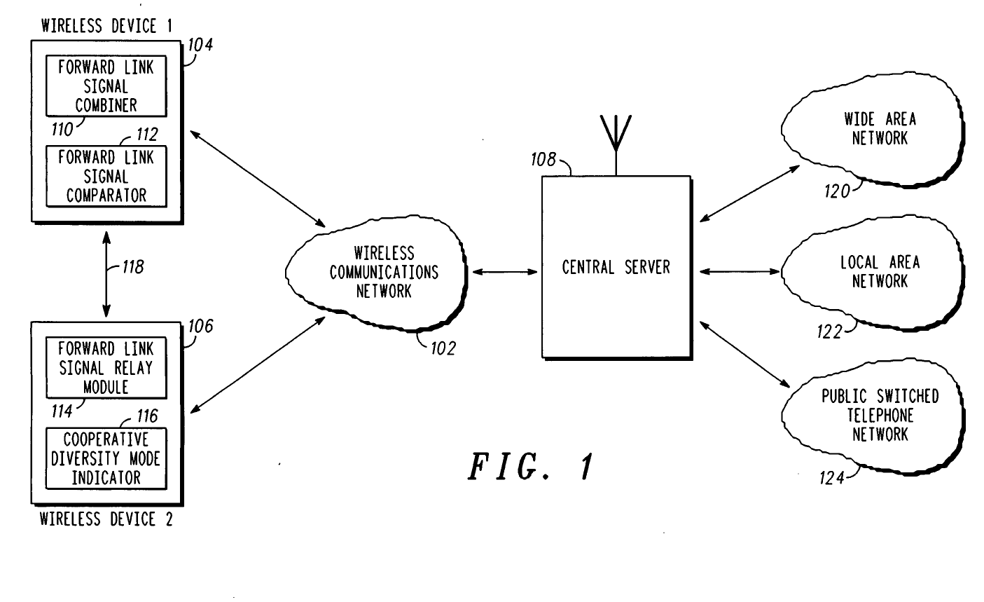

According to an embodiment of the present invention, as shown in FIG. 1, an exemplary wireless communications system 100 is illustrated. FIG. 1 shows a wireless communications network 102, that connects wireless devices such as cooperative diversity wireless device1 104 and cooperative diversity wireless device2 106 with a central server 108. Cooperative diversity allows for a wireless device to act as a diversity receiver for another wireless device and as a target device for receiving relayed signals. For example, the cooperative diversity wireless device2 106 in one embodiment, acts as a diversity receiver for the wireless device1 104 and relays a wireless communication signal such as a forward link signal to the wireless device1 106.

The wireless network 102 comprises a mobile phone network, a mobile text messaging device network, a pager network, or the like. Further, the communications standard of the wireless network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA) or the like. Additionally, the wireless communications network 102 also comprises text messaging standards, for example, Short Message Service (SMS), Enhanced Messaging Service (EMS), Multimedia Messaging Service (MMS), or the like. In one embodiment, the wireless communications network 102 also allows for PoC communications between wireless device1 104 and wireless device2 106.

The wireless network 102 supports any number of wireless devices 104, 106. The support of the wireless network 102 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

In one embodiment, the cooperative diversity wireless devices 104, 106 act as diversity receivers for one or more cooperative diversity wireless devices and/or target devices to receive a relayed wireless communication signals from a diversity receiver. For example, the cooperative diversity wireless device1 104, in one embodiment, establishes a wireless communication link 118 with the cooperative diversity wireless device2 106 so that the cooperative diversity wireless device2 106 can relay wireless communication signals to it. In another embodiment, the cooperative diversity wireless device1 104, acts as a diversity receiver for another cooperative diversity wireless device(s).

For illustration purposes only, FIG. 1 shows the cooperative diversity wireless device1 104 as a target cooperative diversity wireless device and the cooperative diversity wireless device2 106 as a diversity receiver (relay cooperative diversity wireless device). The cooperative diversity wireless device1 104 includes a forward link signal combiner 110 and a forward link signal comparator 112. The forward link signal combiner 110 and the forward link signal comparator 112 will be discussed in greater detail below. The cooperative diversity wireless device2 106 includes, in one embodiment, forward link signal relay module 114 and a cooperative diversity mode indicator 116. The forward link signal relay module 114 and the cooperative diversity mode indicator 116 will be discussed in greater detail below.

Each cooperative diversity wireless device1 104, 106 includes a wireless communication link 118 that allows the cooperative diversity wireless devices 104, 106 to directly communicate with each other or other wireless devices (not shown) without using the wireless network 102. The wireless communication link 118, for example, is provided by Bluetooth, ZigBee, Infrared Data Access (IrDA), ultrasound, WiFi, or any other technology as understood by those of ordinary skill in the art for allowing a direct communication link between the wireless devices 104, 106.

It is noted that each cooperative diversity wireless device1 104, 106 is able to be a diversity receiver for relaying wireless communication signals and/or a target cooperative diversity wireless device for receiving the relayed signals. Therefore, the multi-mode wireless device1 104 and the multi-mode wireless device2 106 are not limited to their respective elements as shown in FIG. 1. For example, each cooperative diversity wireless device1 104, 106 includes the forward link signal combiner 110, the forward link signal comparator 112, the forward link signal relay module 114, and the cooperative diversity mode indicator 116 in accordance with the present invention.

The central server 108 maintains and processes information for all wireless devices such as the cooperative diversity wireless devices 104, 106 communicating on the wireless network 102. Additionally, the central server 108, in this example, communicatively couples the cooperative diversity wireless devices 104, 106 to a wide area network 120, a local area network 122, and a public switched telephone network 124 through the wireless communications network 102. Each of these networks 120, 122, 124 has the capability of sending data, for example, a multimedia text message to the cooperative diversity wireless devices 104, 106.

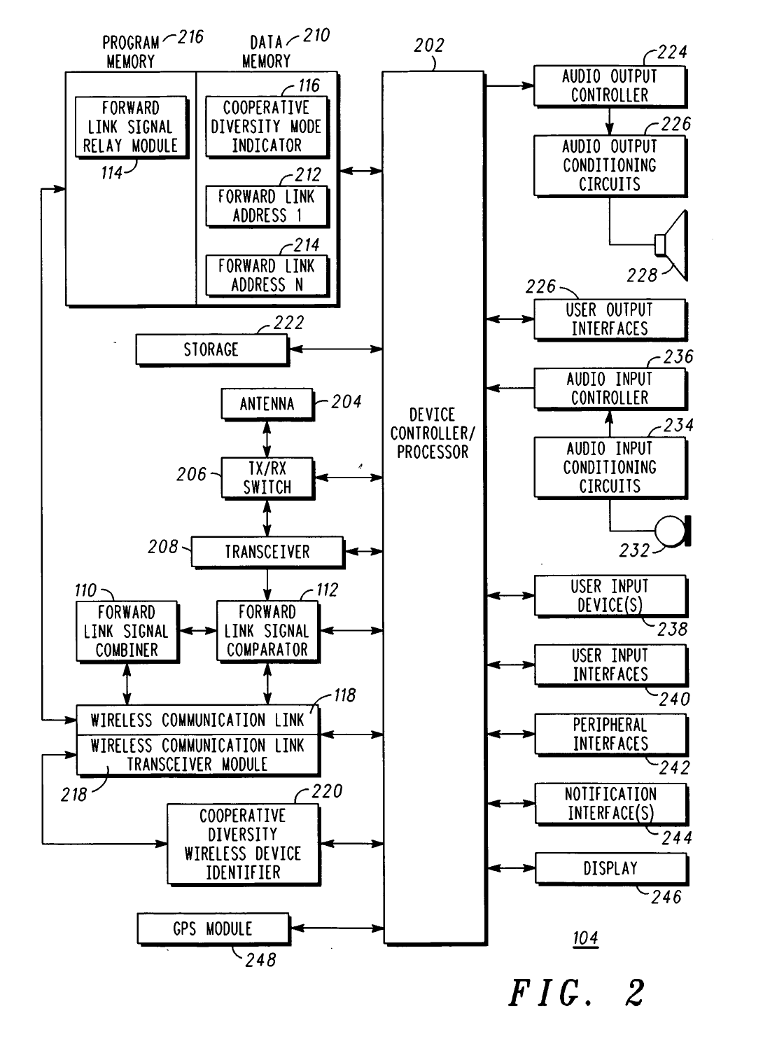

Referring to FIG. 2, a more detailed view of the cooperative diversity wireless device1 104 is illustrated. Although the following discussion is with respect to the cooperative diversity wireless device1 104, it is also applicable to the cooperative diversity wireless device2 106. The cooperative diversity wireless device1 104 operates under the control of a device controller/processor 202, that switches the cooperative diversity wireless device1 104 between receive and transmit modes. In receive mode, the device controller 202 electrically couples an antenna 204 through a transmit/receive switch 206 to a receiver 208. In one embodiment, the transceiver 208 receives forward link signals while in the receive mode. A forward link signal is a signal from a wireless communication device such as a base station. The transceiver 208 decodes the received signals and provides those decoded signals to the device controller 202. In transmit mode, the device controller 202 electrically couples the antenna 204, through the transmit/receive switch 206, to the transceiver 208. The device controller 202 operates the transceiver 208 according to instructions stored in data memory 210. These instructions include, for example, a neighbor cell measurement-scheduling algorithm.

In one embodiment, the cooperative diversity wireless device1 104 is also a multi-mode communication device capable of communicating in a dispatch and/or in an interconnect mode. In this embodiment, the transceiver 208 receives and transmits both interconnect, e.g. cellular and dispatch signals, e.g. PPT/PoC. In another embodiment, a separate dispatch transceiver and interconnect transceiver are included.

The cooperative diversity mode indicator 116 is also included in the data memory 210. The cooperative diversity mode indicator 116, in one embodiment, is an instruction(s) that notifies the cooperative diversity wireless device1 104 that it needs to relay a communication signal such as a forward link signal to another cooperative diversity wireless device. In another embodiment, the cooperative diversity mode indicator 116 notifies the wireless device1 104 that it is in a cooperative diversity target mode. A cooperative diversity target mode is defined as the mode wherein the cooperative diversity wireless device1 104 receives relayed wireless communication signals from one or more cooperative diversity wireless devices. In one embodiment, if the cooperative diversity wireless device1 104 is in a cooperative diversity target mode information (not shown) associated with the cooperative diversity wireless device(s) acting as a diversity receiver for the wireless device1 104 is stored, for example, in the data memory 210.

A forward link address1 212 is also stored in the data memory 210. The forward link address1 212, for example, is the forward link address associated with the cooperative diversity wireless device1 104. When the cooperative diversity wireless device1 104 acts as a diversity receiver for another device, a forward link address such as forward link address N 214 is also stored in the data memory 210. In one embodiment, the data memory has persistent and non-persistent sections. The cooperative diversity mode indicator 116, the forward link address1 212, and the forward link address N 214 can reside in either section of the data memory 210.

Storing the forward link address associated with the target cooperative diversity device allows the cooperative diversity wireless device1 104 to receive the wireless communication signal such as the forward link signal intended for the target cooperative diversity wireless device. For example, in a TDMA system the forward link address 212, 214 corresponds to a time slot in which the cooperative diversity wireless device receives forward link signals. The cooperative diversity wireless device ignores all other forward link signals that are not intended for it, i.e. not being transmitted in its time slot. However, in a cooperative diversity system, the cooperative diversity wireless device acting as a diversity receiver knows the forward link address, e.g. time slot, of the target cooperative diversity wireless device. Accordingly, the cooperative diversity wireless device acting as a diversity receiver also receives the forward link signal for the target cooperative diversity wireless device. The signal is then relayed to the target device.

A forward link signal relay module 114 is included in a program memory 216. The forward link signal relay module 114, for example, comprises instructions for relaying a received forward link signal to the corresponding target cooperative wireless device. The cooperative diversity wireless device1 104 also includes the wireless communication link 118. The wireless communication link 118 allows the cooperative diversity wireless device1 104 to directly communicate with another cooperative diversity wireless device such as cooperative diversity wireless device2 106 without using the wireless network 102. For example, the cooperative diversity wireless device1 104 establishes a wireless communication link 118 with another the cooperative diversity wireless deivce2 106 for relaying and receiving relayed forward link signals. The wireless communication link 118 is provided by Bluetooth, ZigBee, Infrared Data Access (IrDA), ultrasound, WiFi, or any other technology as understood by those of ordinary skill in the art for allowing a direct communication link between the wireless devices 104, 106. In one embodiment, the wireless communication link creates a personal area network between the connected cooperative diversity devices. In another embodiment, the wireless communication link is setup as an ad hoc link so that the link is directly between the devices and a base station is not needed. In an alternate embodiment the wireless communication link 118 is created over a short range radio link.

The wireless communication link 118 is transmitted and received by the wireless communication transceiver module 218. The wireless communication link transceiver module 218 also receives a forward link signal relayed from a cooperative diversity wireless device acting as a diversity receiver for the cooperative diversity wireless device1 104. A cooperative diversity device identifier 220 is also included in the cooperative diversity wireless device1 104. The cooperative diversity device identifier 220 identifies a cooperative diversity wireless device to establish the wireless communication link 118 with. For example, if the strength of the forward link signal being received at the cooperative diversity device1 104 is below a predefined threshold, the cooperative diversity device identifier 220 searches for and identifies a cooperative diversity device to establish the wireless communication link with 118. When a cooperative diversity device is located, the cooperative diversity device identifier 220 communicates with the wireless communication link transceiver module 218 to automatically establish the link 118. In another embodiment, the cooperative diversity device identifier 220 constantly searches for and identifies available cooperative diversity devices. In an alternative embodiment, the cooperative diversity device identifier 220 resides in the wireless communication link transceiver module 218.

In one embodiment, an automatic identification/linking (self-discovery) protocol is used when identifying and connecting to another cooperative diversity device. In another embodiment, a user of the cooperative diversity wireless device1 104 is prompted to connect to another cooperative diversity device. The forward link signal comparator 112 is also included in the cooperative diversity device1 104. The forward link signal comparator 112 compares the forward link signal being received by the transceiver 208 with the relayed forward link signal received at the wireless communication link transceiver module 218. The signals are compared to determine each signal's strength with respect to one another. The forward link signal combiner 110 is also included in the cooperative diversity wireless device1 104 and communicates with the forward link signal comparator 112. The forward link signal combiner 110 combines the forward link signal being received at the cooperative diversity wireless device1 104 by the transceiver 208 with the relayed forward link signal received by the wireless communication link transceiver module 218. The combined signal provides a significantly improved performance over the weaker signal being received at the transceiver 208 because of diversity gain.

One advantage of the present invention is that cooperative diversity enables improved forward link reception for each device in a cooperative diversity pair or group. Improved per device reception results in increased forward link data rates, fewer retransmissions, and overall increased throughput per sector.

The cooperative diversity wireless device1 104 also includes non-volatile storage memory 222. The storage memory 222 retains, for example, an application waiting to be executed (not shown) on the cooperative diversity wireless device1 104. The cooperative diversity wireless device1 104 of FIG. 2 further includes an audio output controller 224 that receives decoded audio output signals from the transceiver 208. The audio output controller 224 sends the received decoded audio signals to the audio output conditioning circuits 226 that perform various conditioning functions. For example, the audio output conditioning circuits 226 may reduce noise or amplify the signal. A speaker 228 receives the conditioned audio signals and allows audio output for listening by a user. The cooperative diversity wireless device1 104 further includes additional user output interfaces 230, for example, a head phone jack (not shown) or a hands-free speaker (not shown).

The cooperative diversity wireless device1 104 also includes a microphone 232 for allowing a user to input audio signals into the cooperative diversity wireless device1 104. Sound waves are received by the microphone 232 and are converted into an electrical audio signal. Audio input conditioning circuits 234 receive the audio signal and perform various conditioning functions on the audio signal, for example, noise reduction. An audio input controller 236 receives the conditioned audio signal and sends a representation of the audio signal to the device controller 202.

The cooperative diversity wireless device1 104 also comprises a user input interface(s) 238 such as a keyboard for allowing a user to enter information into the cooperative diversity wireless device1 104. The user input interface(s) 238 also comprises a camera 240 for allowing a user to capture still images or video images into the data memory 210. Furthermore, additional user input interfaces such as touch screen technology, a joystick, or a scroll wheel are also included. In one embodiment, a peripheral interface 242 is included for allowing the connection of a data cable to the cooperative diversity wireless device1 104. In one embodiment of the present invention, the connection of a data cable allows the cooperative diversity wireless device1 104 to be connected to a computer or a printer.

A notification (or indication) interface(s) 244 is also included on the cooperative diversity wireless device1 104 for rendering a visual notification (or visual indication), for example, a sequence of colored lights on a display 246 or flashing one ore more LEDs (not shown), to the user of the cooperative diversity wireless device1 104. For example, a received multimedia message may include a sequence of colored lights to be displayed to the user as part of the message. Alternatively, the notification interface(s) 244 can be used as an alert by displaying a sequence of colored lights or a single flashing light on the display 248 or LEDs (not shown) when the cooperative diversity wireless device1 104 receives a multimedia message, or the user missed a dispatch, interconnect call, or the like.

The notification interface(s) 244 also includes a tactile interface for delivering a vibrating media component, tactile alert, or the like. For example, a multimedia message received by the cooperative diversity wireless device1 104, may include a video media component that provides a vibration during playback of the multimedia message. The tactile interface, in one embodiment, is used during a silent mode of the cooperative diversity wireless device1 104 to alert the user of an incoming call or message, missed call, or the like. The tactile interface allows this vibration to occur, for example, through a vibrating motor or the like.

The cooperative diversity wireless device1 104 also includes a display 246 for displaying information to the user of the cooperative diversity wireless device1 104 and an optional Global Positioning System (GPS) module 248. The optional GPS module 248 determines the location and/or velocity information of the cooperative diversity wireless device1 104. This module 248 uses the GPS satellite system to determine the location and/or velocity of the cooperative diversity wireless device1 104. Alternative to the GPS module 248, the cooperative diversity wireless device1 104 may include alternative modules for determining the location and/or velocity of cooperative diversity wireless device1 104, for example, using cell tower triangulation, and assisted GPS.

FIG. 3 is a diagram illustrating a cooperative diversity group. FIG. 3 shows a wireless communication cell 302. The wireless communication cell 302 comprises the central server 108 and/or a base station (not shown) within the wireless network 102, the cooperative diversity wireless device1 104, the cooperative diversity wireless device2 106, and a cooperative diversity wireless device N 304. The base station (not shown), in one embodiment, is included at the central server 108. The cooperative diversity devices 104, 106, 304 are within the same sector 306 of the wireless communication cell 302. The central server 108 transmits forward link signals 308, 310, 312 to each of the cooperative diversity wireless devices 104, 106, 304. The strength of the forward link signal 308, 310, 312, in one embodiment, is below a predefined threshold because of, for example, multi-path fading. For example, a cooperative diversity wireless device can be in a city where buildings cause forward link signals to weaken. When a cooperative diversity wireless device determines that the strength of a forward link signal is below a predefined threshold, it establishes a wireless communication link 110, 314, 316 with one or more cooperative diversity wireless devices. For example, the cooperative diversity wireless communication device1 104 establishes a wireless communication link 118, 316 with the cooperative diversity wireless device2 106 and the cooperative diversity wireless device N 304.

The wireless device2 106 and wireless device N 304 are receiving their own forward link signals 310, 312 and the forward link signal 308 intended for the wireless device1 104. By using one or more cooperative diversity devices as a diversity receiver, the cooperative diversity wireless device1 104 is able to achieve improved forward link reception.

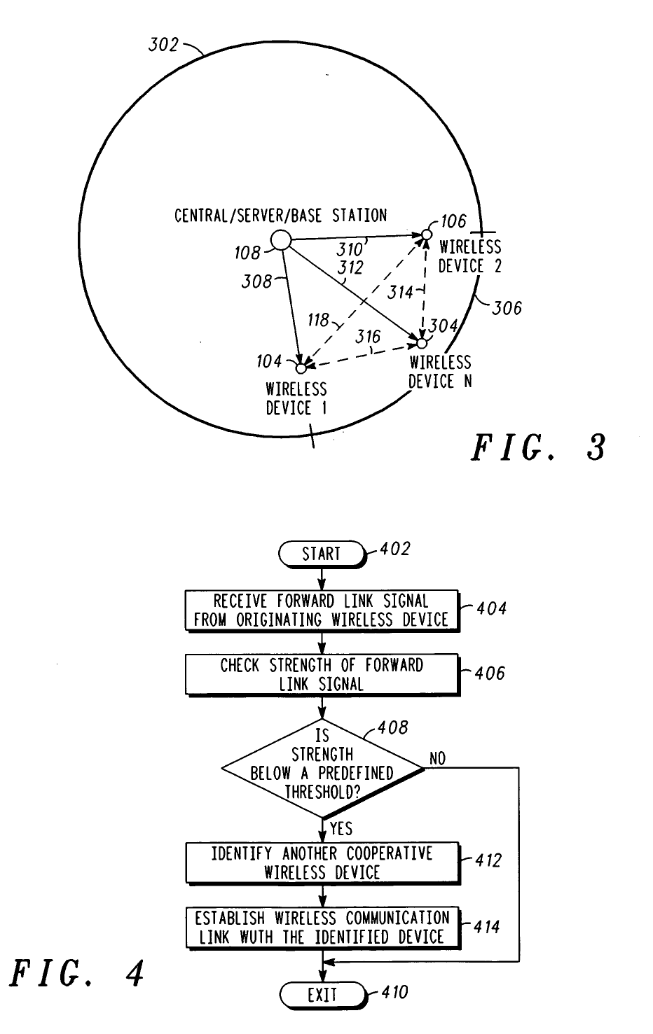

FIG. 4 is an operational flow diagram illustrating an exemplary process of establishing a wireless communication link with another cooperative diversity wireless device. The operational flow diagram of FIG. 4 begins with step 402 and flows directly to step 404. The cooperative diversity wireless device1 104, at step 404, receives a forward link signal from a wireless communication device originating the forward link signal. For example, a central server 108 or a base station (not shown) transmits a forward link signal to the cooperative diversity wireless device1 104.

The cooperative diversity wireless device1 104, at step 406, checks the strength of the received forward link signal. If the strength, at step 408, is determined to be above a predefined threshold, the control flow exits at step 410. If the strength, at step 408, is determined to be below a predefined threshold, a cooperative diversity wireless, at step 412, is identified. In another embodiment, device1 104 is constantly searching for other cooperative diversity devices. For example, as the location of the cooperative diversity wireless device1 104 changes or as cooperative diversity devices come within range of the cooperative diversity wireless device1 104, the cooperative diversity wireless device1 104 identifies cooperative devices. The cooperative diversity wireless device1 104, at step 414, establishes a wireless communication link 118 with the identified cooperative diversity device. The control flow then exits at step 416.

FIG. 5 is an operational flow diagram illustrating an exemplary process of receiving a forward link signal relayed from another cooperative diversity wireless device. The operational flow diagram of FIG. 5 begins with step 502 and flows directly to step 504. The cooperative diversity wireless device1 104, at step 504, transmits forward link address information to a cooperative diversity device(s) in which a wireless communication link 118 has been established with. In one embodiment, the forward link address information is transmitted over the wireless communication link 118.

The cooperative diversity wireless device1 104, at step 506, receives a forward link signal relayed from the cooperative device(s) via a wireless communication link 118. For example, the relaying cooperative diversity device received the forward link signal from its originator using the forward link address information associated with the cooperative diversity wireless device1 104. The relaying device then relays the forward link signal via the wireless communication link to the cooperative diversity wireless device1 104. The cooperative diversity wireless device1 104, at step 508, compares the received relayed forward signal with the forward signal received from its originator. The cooperative diversity wireless device1 104, at step 510, combines the relayed forward link signal and the forward link signal received from its originator such as the central server 108 or base station (now shown). The combined signal gives the cooperative diversity wireless device1 104 improved forward link reception resulting in increased forward link data rates, fewer retransmissions, and overall increased throughput for the sector 306. The control flow then exits at step 512.

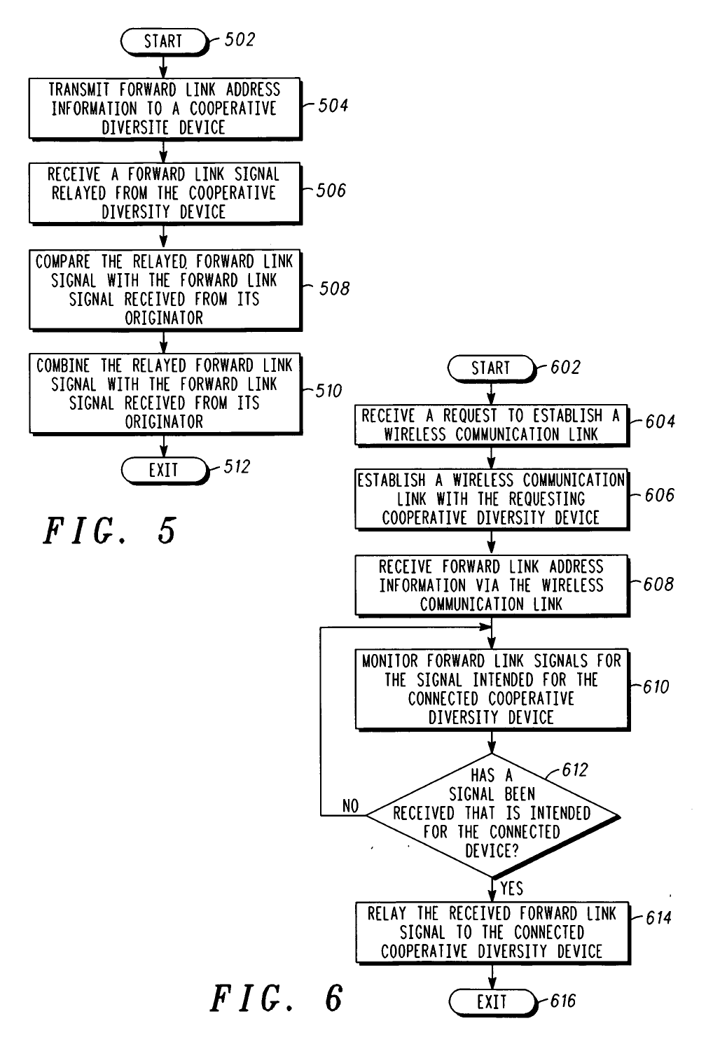

FIG. 6 is an operational flow diagram illustrating an exemplary process of relaying a forward link signal(s) to another cooperative diversity wireless device(s). The operational flow diagram of FIG. 6 begins with step 602 and flows directly to step 604. The cooperative diversity wireless device1 104, at step 604, receives a request from another cooperative diversity wireless device to establish a wireless communication link. The cooperative diversity wireless device1 104, at step 606, establishes a wireless communication link 118 with the requesting cooperative diversity device. The cooperative diversity wireless device1 104, at step 608, receives forward link address information from the target cooperative diversity wireless device. The cooperative diversity wireless device1 104, at step 610, monitors received forward link signals for the forward link signal associated with the connected target cooperative diversity wireless device.

The cooperative diversity wireless device1 104, at step 612, determines whether a forward link signal associated with the target cooperative diversity wireless device has been received. If the result of this determination is negative, the cooperative diversity wireless device1 104 continues to monitor for the forward link signal. If the result of this determination is positive, the cooperative diversity wireless device1 104, at step 614, relays the forward link signal to the target cooperative diversity wireless device. The control flow then exits at step 616.

An advantage of the present invention is that wireless devices receiving a weak forward link signal can have other wireless devices act as a diversity receiver to improve the forward link signal. The wireless devices are then able to combine forward link signals received, for example, from a base station and from the wireless devices acting as diversity receivers in order to obtain a stronger forward link signal. Accordingly, forward link data rates are increased, fewer retransmissions occur, and overall increased throughput per sector is achieved.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for cooperative diversity wireless communication, the method comprising:
detecting at least one relay wireless device;
establishing a wireless communication link with the at least one relay wireless device;
transmitting, via the wireless communication link, forward link address information of a target wireless device to the at least one relay wireless device and an instruction to transmit to the target wireless device, via the wireless communication link, a forward link wireless communication data signal received by the at least one relay wireless device, the forward link wireless communication data signal being destined for reception by the target wireless device.

2. The method of claim 1, further comprising:
receiving a wireless communication data signal, via the wireless communication link, transmitted from the at least one relay wireless device, the wireless communication data signal corresponding to the forward link wireless communication data signal transmitted via a wireless communication network channel and destined for reception by the target wireless device.

3. The method of claim 1, wherein wireless communication link is established automatically with the at least one relay wireless device.

4. The method of claim 1, wherein the wireless communication link creates a personal area network between the target wireless device and the at least one relay wireless device.

5. The method of claim 4, wherein the personal area network is an ad hoc network.

6. The method of claim 1, wherein the wireless communication link is established using a short range radio signal.

7. The method of claim 1, further comprising:
receiving a forward link wireless communication data signal from an originating wireless device, the originating wireless device originating the forward link wireless communication data signal.

8. The method of claim 7, further comprising:
combining the at least one forward link signal received from the at least one relay wireless device with the forward link wireless communication data signal received from the originating wireless communication device.

9. A wireless device for cooperative diversity wireless communication, the wireless device comprising:
a controller for enabling a forward link address information send operation of a target wireless device; and
a wireless communication link, communicatively coupled with the controller, for directly communicating with at least one relay wireless communication device;
a transmitter, communicatively coupled with the controller, for transmitting the forward link address information from the target wireless device, via the wireless communication link, to the at least one relay wireless device and an instruction to transmit to the target wireless device, via the wireless communication link, a forward link wireless communication data signal received by the at least one relay wireless device, the forward link wireless communication data signal being destined for reception by the target wireless device.

10. The wireless device of claim 9, further comprising:
a receiver for receiving a wireless communication data signal, via the wireless communication link, transmitted from the at least one relay wireless device, the wireless communication data signal corresponding to a forward link wireless communication data signal transmitted via a wireless communication network channel and destined for reception by the target wireless device.

11. The wireless device of claim 9, wherein wireless communication link is established automatically with the at least one relay wireless device.

12. The wireless device of claim 9, wherein the wireless communication link creates a personal area network between the target wireless device and the at least one relay wireless device.

13. The wireless device of claim 12, wherein the personal area network is an ad hoc network.

14. The wireless device of claim 9, wherein the wireless communication link is established using a short range radio signal.

15. The wireless device of claim 9, further comprising:
receiving a forward link wireless communication data signal from an originating wireless device, the originating wireless device originating the forward link wireless communication data signal.

16. The wireless device of claim 15, further comprising:
combining the at least one forward link signal received from the at least one relay wireless device with the forward link wireless communication data signal received from the originating wireless communication device.

17. A wireless communication system for cooperative diversity wireless communication comprising:
at least one target wireless device, each such target wireless device comprising:
a controller for enabling a forward link address information send operation of a target wireless device; and
a wireless communication link, communicatively coupled with the controller, for directly communicating with at least one relay wireless communication device;
a transmitter, communicatively coupled with the controller, for transmitting the forward link address information from the target wireless device, via the wireless communication link, to the at least one relay wireless device and an instruction to transmit to the target wireless device, via the wireless communication link, a forward link wireless communication data signal received by the at least one relay wireless device, the forward link wireless communication data signal being destined for reception by the target wireless device; and
the at least one relay device comprising:
a controller;
a memory, communicatively coupled with the controller, for storing the forward link address information transmitted from the target wireless device;
a receiver, communicatively coupled with the controller, for receiving at least one forward link wireless communication data signal destined for reception by the at least one target wireless device; and
a wireless communication link, communicatively coupled with the controller, for at least:
receiving the forward link address information transmitted by the at least one target wireless device; and
transmitting a wireless communication data signal corresponding to the at least one forward link wireless communication data signal to the at least one target wireless device.

18. The system of claim 17, wherein the wireless communication link of the at least one target wireless device receives a wireless communication data signal, via the wireless communication link, transmitted from the at least one relay wireless device, the wireless communication data signal corresponding to the forward link wireless communication data signal transmitted via a wireless communication network channel and destined for reception by the target wireless device.

19. The system of claim 17, wherein the wireless communication link of the at least one target wireless device and the at least one relay wireless device creates an ad hoc network between the at least one target wireless device and the at least one relay wireless device.

20. The system of claim 17, wherein the at least one target wireless device further comprises:
a receiver for receiving a forward link wireless communication data signal from an originating wireless device, the originating wireless device originating the forward link wireless communication data signal; and
a forward link signal combiner for combining the at least one forward link signal received from the at least one relay wireless device with the forward link wireless communication data signal received from the originating wireless communication device.
